(19) United States
(12) Patent Application Publication
(10) Pub. No.: US 2004/0062683 A1
(43) Pub. Date: Apr. 1, 2004

(54) Sensitive single-layer sensing device of covalently attached luminescent indicator on glass surface for measuring the concentration of analytes

(75) Inventors: Vivian Wing-Wah Yam, Hong Kong (CN); Ben Wai-Kin Chu, Hong Kong (CN)

Correspondence Address: JONES DAY, 222 EAST 41ST STREET, NEW YORK, NY, 10017, US

(73) Assignee: The University of Hong Kong

(21) Appl. No.: 10/261,191

(22) Filed: Sep. 30, 2002

(51) Int. Cl. G01N 21/00

(52) U.S. Cl. 422/58

(57) ABSTRACT

A sensing element which contains a single layer of luminescent indicator of ruthenium complexes covalently attached onto the glass surface is described. The system is capable of detecting analyte, for example, oxygen, concentration in gases or in dissolved condition in fluids by luminescence quenching of the said indicator to analyte. The sensitive single-layer system achieves reproducible and short response behavior.

### FIELD OF THE INVENTION

The invention is related to a method of producing a sensitive single-layer element of luminescent ruthenium(II) complexes covalently attached onto the glass surface for optical detection of concentration of analyte, for example, oxygen, in gases or in fluids by luminescence quenching of the said indicator to analyte.

### BACKGROUND OF THE INVENTION

Early optical oxygen sensing schemes used organic sensors which were based on the fluorescence from polycyclic aromatic hydrocarbons (PAHs) with long excited-state lifetimes, such as pyrene, benzo[a]pyrene, pyrenebutyric acid, and decacyclene. These fluorophores have reasonably long excited-state lifetimes (up to 400 ns) and are susceptible to O₂ quenching. However, they also exhibit absorbance maxima in the ultraviolet or blue spectral region. As a result, the high-energy excitation light sources in these optical sensing schemes consume significant electrical power and/or are expensive. Additionally, the detectors needed for these optical sensing schemes (for example, PMT) are costly and require high voltage power supplies.

To overcome the shortages mentioned above, the present invention describes a method of manufacturing a sensitive single-layer system based on a transition metal complex for measuring the concentration or the partial pressure of analytes, by means of which a reproducible and extremely short response behavior becomes obtainable.

A variety of metal-organic compounds of a number of transition metals and lanthanides are known to be intensely luminescent. Luminescent transition metal complexes, especially of d⁶ platinum metals such as ruthenium, osmium, rhenium, rhodium and iridium with diimine type ligands (for example, 2,2′-bipyridine, 1,10-phenanthroline and their substituted derivatives) exhibit very desirable features in terms of their optical spectra, excited state lifetimes and luminescence quantum yields. The low-lying metal-to-ligand charge transfer (MLCT) excited state(s) of ruthenium(II) bipyridyl complexes has been used in a number of photosensitization schemes since their luminescence can be quenched by a variety of reagents including molecular oxygen. The other reasons for their popularity are their easy preparation and relatively stable toward photodecomposition, excited state luminescence in the visible region and long-lived lifetime in solution at room temperature, and a wide choice of ligands which can be used to fine-tune the relative energy levels of the excited states and the transition energies, making the complexes possible to provide tailor-made luminophores for fabricating a variety of sensors for environmental, oceanographic, industrial, biotechnological and biomedical applications.

A general type of optical device for monitoring the partial pressure of oxygen can be based on the use of ruthenium(II) complexes as luminescent sensors. The properties of such complexes are described in Klassen et al., “Spectroscopic Studies of Ruthenium(II) Complexes. Assignment of the Luminescence”, The Journal of Chemical Physics, 1968, 48, 1853-1858, and in Demas et al., “Energy Transfer from Luminescent Transition Metal Complexes to Oxygen”, Journal of the American Chemical Society, 1977, 99, 3547-3551.

Most optical sensing schemes are based on the quenching of a luminescent species by a gas, such as molecular oxygen. In this approach, the O₂ dependence on the emission intensity is described by the Stern-Volmer expression:

Iₒ/I=(Σ[fₙ/(1+Kₛᵥₙ[O₂])])⁻¹ Equation 1:

where fₙ is the fractional contribution from each oxygen-accessible site and Kₛᵥₙ, is the quenching constant for each accessible site.

Three immobilization methods are commonly used for the preparation and immobilization of chemical/biochemical species. They are chemical covalent, physical and electrostatic techniques. Physical immobilization or encapsulation involves adsorption and inclusion of molecules in polymer matrices (e.g. silicon rubber or sol gel). This is the simplest and therefore the least expensive way of immobilization. However, in this type of immobilization there is no bonding between the sensing reagent and the polymeric support and the immobilized luminophores can leach out. Electrostatic immobilization uses rigid polymer supports with charged groups such as sulfonic (sulfonated polystyrene) or quaternized ammonium groups capable of binding electrostatically to molecules of opposite charge. However, the reproducibility of electrostatic immobilization is decreased by non-homogeneous distribution of sensing materials and their bleeding on long-term use. The most effective immobilization procedure is one in which a chemical bond is formed between the substrate such as sol-gel and the species to be immobilized. Although immobilization often results in attenuation of various characteristics of a reactive species, metal-organic luminophore has demonstrated the possibility of chemical immobilization while maintaining most of their useful optical, photophysical and photochemical characteristics. Chemically immobilized luminophores can be cast in ultrathin films containing evenly distributed sensing material. Ultrathin films containing immobilized luminophores can be used to produce fiber-optic sensors with very short response times. Unfortunately, the uniformity of the fabricated sensors can only be maintained by controlling various parameters such as the pH of sol-gel, spin speed in spin-coating and concentration of the sensing material in substrate. We herein describe a method of fabricating a sensitive single-layer system of ruthenium(II) bipyridyl complex with functionalized ligand, which is chemically bonded onto the glass surface.

### SUMMARY OF THE INVENTION

Chemical immobilization, which involves formation of a covalent bond between sensing reagent or luminophore and the glass surface, is also known as covalent immobilization. Covalent bond formation is considered the best technique for immobilization of both chemical and biochemical species because of the stable and predictable nature of the covalent chemical bond. The modification usually involves surface modification of the glass surface through chemical reactions. In order to covalently immobilize the ‘sensing reagent’, it should essentially contain one or more point of attachment.

One of the advantages of the present invention is that the wavelengths of both the excitation (blue) and emission (red) light are in visible region. This can reduce the manufacturing cost of the system as the sensing system can be easily constructed with low cost substitutes like an inexpensive light emitting diode and a low cost photodiode. Another advantage of the present invention is the easiness of fabricating uniform single-layer sensing device. The parameters of controlling the thickness and surface concentration can be easily kept constant. Yet another advantage of the present invention is the fast response times, good reversibility, large signal response and its ability to operate in both a gaseous phase and an aqueous phase without the problem of leaching.

### DETAILED DESCRIPTION OF THE INVENTION

FIG. 1 shows the synthesis of functionalized ligand. 4,4′-Dimethyl 2,2′-bipyridine (0.5 g) is added to lithium diisopropyl amide (LDA), which is prepared by reacting ⁿBuLi with diisopropylamine in dry THF at 0° C. for 1 hour, under nitrogen for 1 hour. Br(CH₂)₂OTHP (THP=tetrahydropyranyl) in THF is then added. The mixture is stirred between 0° C. and room temperature overnight. Methanol is added to the mixture to destroy any unreacted LDA and the solvent is removed by rotary evaporator. Water is added and the mixture is extracted by ethyl acetate. The compound is dissolved in ethanol with p-toluenesulfonic acid and the mixture is stirred overnight. The ethanol is removed by rotary evaporator. Water is added and the mixture is extracted by ethyl acetate. The organic layer is separated, washed with water, dried with magnesium sulfate and the solvent is evaporated to give product as white crystalline solid.

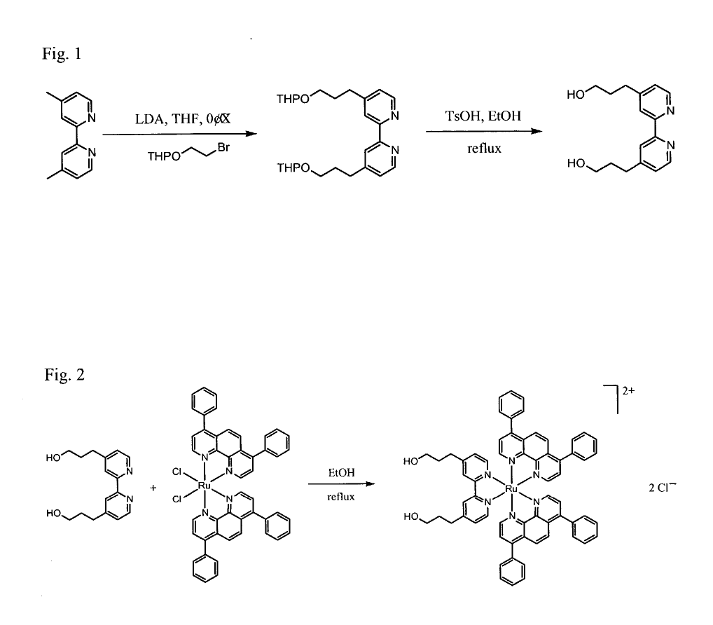

FIG. 2 shows the synthesis of metal-polypyridine complexes. The starting material cis-[Ru(4,7-diphenyl-1,10-phenanthroline)₂Cl₂].2H₂O was synthesized according to a published procedure [Sullivan et al., Inorganic Chemistry, 1978, 17, 3334-3341] with 4,7-diphenyl-1,10-phenanthroline used instead of 2,2′-bipyridine. cis-[Ru(4,7-diphenyl-1,10-phenanthroline)₂Cl₂].2H₂O and the ligand prepared in FIG. 1 are heated to reflux in ethanol for 12 hours. All solvent is then evaporated by rotary evaporator.

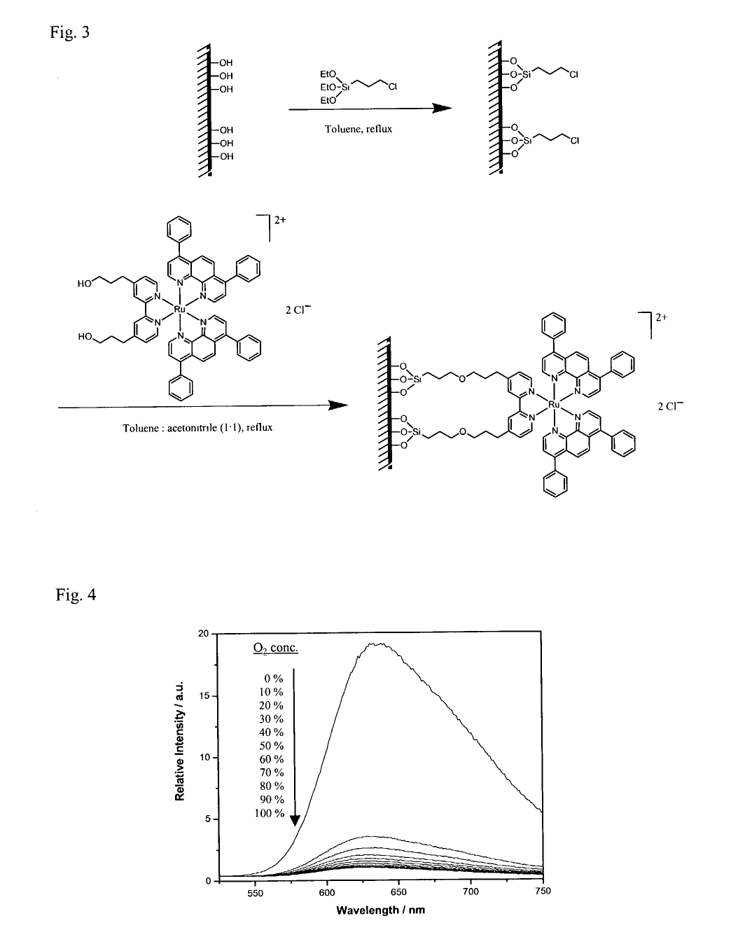

FIG. 3 shows the surface modification of glass surface and the immobilization of metal complex. A glass slide is immersed in a toluene solution of a 3-chloropropylsilyl reagent. It is heated to reflux under nitrogen for 3 hours. The glass slide is then cleaned by sonication in acetone for 10 minutes. The ruthenium(II) complex with functionalized ligand prepared in FIG. 2 and the clean surface modified glass slide were heated to reflux in toluene and acetonitrile mixture (1:1) for 12 hours. The glass slide is then cleaned by sonication in acetone and methanol each for 10 minutes.

FIG. 4 shows the emission spectral traces of single-layer ruthenium(II) bipyridyl sensing material on a glass slide under various oxygen concentrations. The excitation wavelength was 485 nm.

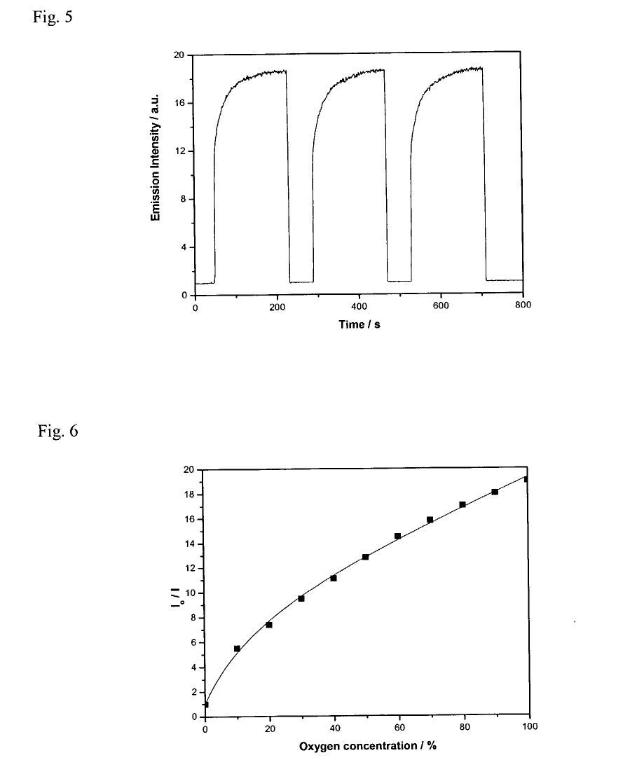

FIG. 5 shows the response time of relative emission intensity changes for the single-layer ruthenium(II) bipyridyl sensing material on a glass slide on switching between 100% oxygen and 100% nitrogen. The excitation and emission wavelengths were 485 nm and 630 nm, respectively. The response times of the sensor are 160 s on going from nitrogen to oxygen and almost spontaneous on going from nitrogen to oxygen. The signal changes were fully reversible and measurement hysteresis was not observed.

FIG. 6 shows the Stern-Volmer plot of the single-layer ruthenium(II) bipyridyl sensing material on a glass slide. The best-fit curve was obtained when n=2, which is commonly observed in other oxygen sensor based on transition metal complexes. The equation can be derived from eq. 1 and expressed as:

$${I}_{0} / I = {( \frac{{f}_{1}}{1 + {K}_{sv1} [ Q ]} + \frac{{f}_{1}}{1 + {K}_{sv2} [ Q ]} )}^{- 1} \qquad Equation 2 :$$

The correlation factor of the plot, r², as estimated to be 0.998 by the least-squares method, indicating that there are two oxygen-accessible sites: one is oxygen accessible (Kₛᵥ₁=0.6135%⁻¹,f₁=0.929) and the other is an oxygen difficult accessible site (K^{sv2}=0.0092%⁻¹,f₂=0.071).

We claim:

1. A device for measuring concentration of analytes, comprising: A transparent monolayer of luminescent indicator which is covalently attached to the surface of substrate.

2. A device for measuring concentration of analytes as recited in claim 1, wherein the luminescent indicator consisting of the general formula [M(N,N)₂(P-((CH₂)ₘ—X-(CH₂)ₙ—Si)ₛ-G)]Y₂, wherein M is Ru(II), Os(II) Rh(III) or Ir(III); N,N is an diimine bidentate ligand, for example, 2,2′-bipyridine, 1,10-phenanthroline, or 4,7-diphenyl-1,10-phenanthroline; P is a diimine bidentate ligand, for example, bipyridine or phenanthroline; m and n independently have numerical values between 0 and 10; X is a an heteroatom, such as O or N; G is the surface of substrate; s has numerical value equal to or greater than 1. Y is a Cl, Br, I, PF₆, BF₄, ClO₄, NO₃, NCS, SO₃CF₃, SbF₆ anion.

3. A device for measuring concentration of analytes as recited in claim 1, wherein the substrate comprises a glass or an optic fiber.

4. A device for measuring concentration of analytes as recited in claim 1 for detecting analytes in gases or fluids.

5. A device for measuring concentration of analytes as recited in claim 1, wherein the said oxygen-sensitive luminescent dye is made of any oxygen-responsive, luminescent salt of a transition metal complex having as a ligand derivative of 2,2′-bipyridine or 1,10-phenanthroline.

6. A device for measuring concentration of analytes as recited in claim 1, further comprising a gas-permeable membrane.

7. A system for measuring the concentration of analytes with single or multiple components of said device as recited in claim 1.

8. A system for measuring the concentration of analytes with single or multiple excitation light passing through components of said device as recited in claim 1.
